(19) United States
(12) Patent Application Publication
(10) Pub. No.: US 2006/0128927 A1
(43) Pub. Date: Jun. 15, 2006

(54) Reactive polyurethane prepolymers with low monomeric diisocyanate content

(76) Inventors: Christoph Gurtler, Koln (DE); Matthias Wintermantel, Koln (DE)

Correspondence Address: BAYER MATERIAL SCIENCE LLC, 100 BAYER ROAD, PITTSBURGH, PA, 15205, US

(21) Appl. No.: 11/301,626

(22) Filed: Dec. 13, 2005

(30) Foreign Application Priority Data
Dec. 15, 2004 (DE) 102004060284.0

(51) Int. Cl. C08G 18/16

(52) U.S. Cl. 528/48; 528/44

(57) ABSTRACT

The present invention relates to reactive polyurethanes having a low monomeric diisocyanate content and also to their preparation and their use in reactive one- and two-component adhesives/sealants, assembly foams, casting compounds, and also flexible, rigid and integral foams. The polyurethanes are prepared in the presence of zirconium(IV) acetylacetonate complexes as catalyst, where at least one acetylacetonate ligand present in the catalyst bears a fluorine substituent.

### CROSS-REFERENCE TO RELATED APPLICATION

This application claims priority to German application DE 10 2004 060284, filed Dec. 15, 2004.

### FIELD OF THE INVENTION

The present invention relates to reactive polyurethanes having a low monomeric diisocyanate content and also to their preparation and their use in reactive one- and two-component adhesives/sealants, assembly foams, casting compounds, and also flexible, rigid and integral foams.

### BACKGROUND OF THE INVENTION

In these applications it is common to use what are known as isocyanate (NCO) prepolymers, which can then be cured with water (as what is called a 1K [1-component] system) or with alcohols or amines (as a 2K [2-component] system). These NCO prepolymers preferably contain terminal isocyanate (NCO) groups.

To obtain polyurethanes with terminal NCO groups it is usual to react polyfunctional alcohols with an excess of monomeric polyisocyanates, generally diisocyanates, and after the reaction to remove any unreacted isocyanate again.

Often, however, residual monomer contents are obtained which are too high for the products to be used as low-monomer-content products, with no need for labelling, in the adhesives and sealants sector-products which can also be processed at elevated application temperatures without heightened workplace safety measures.

Furthermore, monomeric isocyanates contained in coatings, adhesive bonds or sealants may migrate over the course of time or may, by reaction with atmospheric moisture, lead to the release of CO₂ and the corresponding amines, from which, in turn, other unwanted qualities may arise.

Within the food packaging sector the amount of amines arising due to migrated diisocyanates, and particularly of primary aromatic amines, must be below the aniline hydrochloride-based detection limit of 0.2 microgram of aniline hydrochloride/100 ml of sample (Bundesinstitut für gesundheitlichen Verbraucherschutz und Veterinärmedizin [German Federal Institute of Consumer Health Protection and Veterinary Medicine], BGVV, according to official collection of analytical methods under § 35 LMBG [German Food and Commodities Act]—Analysis of foodstuffs/determination of primary aromatic amines in aqueous test foods).

There is therefore a need for reactive polyurethanes and/or polyurethane prepolymers, and reactive one- and two-component adhesives/sealants, assembly foams, casting compounds, and also flexible, rigid and integral foams, based thereon, having a drastically reduced fraction of monomeric diisocyanates of preferably below 0.1% by weight.

In addition it is desirable for the NCO prepolymers prepared to have extremely low viscosities, so that during processing and application of the adhesives and sealants there is, as far as possible, no need to add additional solvent in order to adjust viscosity.

For preparing such NCO-functional prepolymers which meet the above conditions for the sealants and adhesives sector use is made typically of organotin compounds such as dibutyltin dilaurate (DBTL) or bismuth carboxylates.

Tin compounds, however, are hampered by their toxicity, particularly in a food contact context. Bismuth carboxylates, in contrast, are considered toxicologically unobjectionable; they lead to somewhat higher viscosities in the end products in conjunction with likewise very low residual monomer contents.

### SUMMARY OF THE INVENTION

The object of the present invention, then, was therefore to find catalysts which in the prepolymer lead to at least the same low residual monomer contents as when using the aforementioned classes of catalyst but do not have the toxicity of tin compounds and lead to prepolymers which preferably have lower viscosities than prepolymers prepared similarly using bismuth catalysts.

Surprisingly it has now been found that specific fluorine-bearing zirconium(IV) acetylacetonate complexes achieve the stated object.

The invention accordingly provides for the use of zirconium(IV) acetylacetonate complexes as urethanization catalysts, with at least one acetylacetonate ligand present in the catalyst bearing a fluorine substituent.

Thus, in one aspect, the present invention provides a process for preparing urethane-containing compounds comprising the step of reacting an isocyanate-containing compound with an isocyanate-reactive compound in the presence of zirconium(IV) acetylacetonate complexes as catalyst, where at least one acetylacetonate ligand present in the catalyst bears a fluorine substituent.

Further provided by the present invention is a process for preparing NCO-functional polyurethane prepolymers having an NCO content of 0.2%-12% by weight, in which at least one monomeric asymmetric diisocyanate having a molecular weight of 160 g/mol to 500 g/mol and at least one polyetherpolyol and/oder polyesterpolyol are reacted with one another in the presence of zirconium(IV) acetylacetonate complexes, at least one acetylacetonate ligand present in the catalyst bearing a fluorine substituent, in a ratio of isocyanate groups to hydroxyl groups of 1.05:1 to 2.0:1.

### DETAILED DESCRIPTION OF PREFERRED EMBODIMENTS

As used herein, as used in the examples or unless otherwise expressly specified, all numbers may be read as if prefaced by the word “about”, even if the term does not expressly appear. Also, any numerical range recited herein is intended to include all sub-ranges subsumed therein.

The zirconium(IV) acetylacetonate complexes for use in accordance with the invention preferably bear at least one CF₃ group per acetylacetonate ligand, and with particular preference the zirconium(IV) acetylacetonate complexes contain exclusively acetylacetonate ligands having at least one CF₃ group. Very particular preference is given to tris(1,1,1-trifluoro-acetylacetonato)zirconium(IV) and tris(1,1,1,5,5,5-hexafluoroacetylacetonato)zirconium(IV).

Further provided by the present invention is a process for preparing NCO-functional polyurethane prepolymers having an NCO content of 0.2%-12% by weight, in which at least one monomeric asymmetric diisocyanate having a molecular weight of 160 g/mol to 500 g/mol and at least one polyetherpolyol and/oder polyesterpolyol are reacted with one another in the presence of zirconium(IV) acetylacetonate complexes, at least one acetylacetonate ligand present in the catalyst bearing a fluorine substituent, in a ratio of isocyanate groups to hydroxyl groups of 1.05:1 to 2.0:1.

The NCO content of the reactive polyurethane prepolymers thus obtainable is preferably 0.5% to 10% by weight and with particular preference 1.0% to 8% by weight.

Monomeric asymmetric diisocyanates A) for the purposes of this invention are aromatic, aliphatic or cycloaliphatic diisocyanates having a molecular weight of 160 g/mol to 500 g/mol which possess NCO groups having a different reactivity towards polyols. The different reactivity of the NCO groups of the diisocyanate comes about through differently adjacent substituents to the NCO groups on the molecule, which by means of steric shielding, for example, lower the reactivity of one NCO group in comparison to the other NCO group and/or, by means of different binding of an NCO group to the remainder of the molecule, in the form for example of a primary or secondary NCO group, for example.

Examples of suitable aromatic asymmetric diisocyanates are 2,4-tolylene diisocyanate (2,4-TDI), naphthalene 1,8-diisocyanate (1,8-NDI) and diphenylmethane 2,4′-diisocyanate (2,4′-MDI).

Examples of suitable cycloaliphatic asymmetric diisocyanates are 1-isocyanatomethyl-3-isocyanato-1,5,5-trimethylcyclohexane (isophorone diisocyanate, IPDI), 1-methyl-2,4-diisocyanatocyclohexane or hydrogenation products of the aforementioned aromatic diisocyanates, especially hydrogenated 2,4′-MDI.

Examples of aliphatic asymmetric diisocyanates are 1,6-diisocyanato-2,2,4-trimethylhexane, 1,6-diisocyanato-2,4,4-trimethylhexane and lysine diisocyanate. Preferred asymmetric diisocyanates are 2,4-tolylene diisocyanate (2,4-TDI), diphenylmethane 2,4′-diisocyanate (2,4′-MDI) and 1-isocyanatomethyl-3-isocyanato-1,5,5-trimethylcyclohexane (isophorone diisocyanate, IPDI).

In the context of the invention diphenylmethane 2,4′-diisocyanate (2,4′-MDI) comprehends a polyisocyanate having a 2,4′-MDI content of more than 95% by weight, more preferably of more than 97.5% by weight. Additionally the 2,2′-MDI content is below 0.5% by weight, more preferably below 0.25% by weight.

In the context of the invention 2,4-tolylene diisocyanate (2,4-TDI) comprehends a polyisocyanate having a 2,4-TDI content of more than 95% by weight, preferably of more than 97.5% by weight, and very preferably of more than 99% by weight. As polyol component B) it is possible to use the polyetherpolyols and/or polyesterpolyols that are known per se from polyurethane chemistry.

The polyetherpolyols which can be used as polyol component B) are known per se to the skilled person from polyurethane chemistry. They are typically obtained starting from low molecular weight, polyfunctional OH- or NH-functional compounds as starters by reaction with cyclic ethers or mixtures of different cyclic ethers. Catalysts used here are bases such as KOH or double metal cyanide-based systems. Preparation processes suitable for this purpose are known to the skilled person per se from, for example, U.S. Pat. No. 6,486,361 or L. E. St. Pierre, Polyethers Part I, Polyalkylene Oxide and other Polyethers, Editor: Norman G. Gaylord; High Polymers Vol. XIII; Interscience Publishers; Newark 1963; p. 130 ff.

Suitable starters have preferably 2-8, more preferably 2-6 hydrogen atoms capable of polyaddition with cyclic ethers. Examples of compounds of this kind are water, ethylene glycol, 1,2- or 1,3-propylene glycol, 1,3-butanediol, 1,4-butanediol, 1,6-hexanediol, bisphenol A, neopentyl glycol, glycerol, trimethylolpropane, pentaerythritol and sorbitol.

Suitable cyclic ethers include alkylene oxides such as ethylene oxide, propylene oxide, butylene oxide, epichlorohydrin or styrene oxide or tetrahydrofuran.

Preferred polyetherpolyols used in B) are polyethers based on the aforementioned starters and containing propylene oxide, ethylene oxide and/or tetrahydrofuran units, more preferably containing propylene oxide and/or ethylene oxide units.

The polyetherpolyols that are suitable as polyol component B) have number-average molecular weights of 200 to 20 000 g/mol, preferably 500 to 12 000 g/mol and more preferably 1000 to 8000 g/mol. Definitive for the molecular weight is the OH number of the polyol, determined in accordance with DIN 53240.

By the polyesterpolyols which can be used as polyol component B) are meant, in the context of the present invention, polyesters having more than one OH group, preferably two terminal OH groups. Polyesters of this kind are known to the skilled person.

Thus it is possible, for example, to use polyesterpolyols which come about through reaction of low molecular weight alcohols, especially of ethylene glycol, diethylene glycol, neopentyl glycol, hexanediol, butanediol, propylene glycol, glycerol or trimethylolpropane, with caprolactone. Likewise suitable as polyfunctional alcohols for preparing polyesterpolyols are 1,4-hydroxymethylcyclohexane, 2-methyl-1,3-propanediol, butane-1,2,4-triol, triethylene glycol, tetraethylene glycol, polyethylene glycol, dipropylene glycol, polypropylene glycol, dibutylene glycol and polybutylene glycol.

Further suitable polyesterpolyols can be prepared by polycondensation. For instance, difunctional and/or trifunctional alcohols can be condensed with a substoichiometric amount of dicarboxylic and/or tricarboxylic acids, or reactive derivatives thereof, to form polyesterpolyols. Examples of suitable dicarboxylic acids are adipic acid or succinic acid and their higher homologs having up to 16 carbon atoms, and also unsaturated dicarboxylic acids such as maleic acid or fumaric acid, and aromatic dicarboxylic acids, particularly the isomeric phthalic acids, such as phthalic acid, isophthalic acid or terephthalic acid. Examples of suitable tricarboxylic acids include citric acid and trimellitic acid. The said acids can be used individually or as mixtures of two or more of them. Particularly suitable alcohols are hexanediol, butanediol, ethylene glycol, diethylene glycol, neopentyl glycol, 3-hydroxy-2,2-dimethylpropyl 3-hydroxy-2,2-dimethylpropanoate or trimethylolpropane or mixtures of two or more thereof.

Particularly suitable acids are phthalic acid, isophthalic acid, terephthalic acid, adipic acid or dodecanedioic acid or mixtures thereof.

Polyesterpolyols of high molecular weight embrace, for example, the reaction products of polyfunctional, preferably difunctional alcohols (together optionally with small amounts of trifunctional alcohols) and polyfunctional, preferably difunctional carboxylic acids. Instead of free polycarboxylic acids use may be made (if possible) alternatively of the corresponding polycarboxylic anhydrides or corresponding polycarboxylic esters with alcohols having preferably 1 to 3 carbon atoms. The polycarboxylic acids can be aliphatic, cycloaliphatic, aromatic or heterocyclic or both. They may optionally be substituted, by alkyl groups, alkenyl groups, ether groups or halogens, for example. Examples of suitable polycarboxylic acids include succinic acid, adipic acid, suberic acid, azelaic acid, sebacic acid, dodecanedioic acid, phthalic acid, isophthalic acid, terephthalic acid, trimellitic acid, phthalic anhydride, tetrahydrophthalic anhydride, hexahydrophthalic anhydride, tetrachlorophthalic anhydride, endomethylenetetrahydrophthalic anhydride, glutaric anhydride, maleic acid, maleic anhydride, fumaric acid, dimer fatty acid or trimer fatty acid or mixtures of two or more thereof.

Polyesters obtainable from lactones, based for example on ε-caprolactone, also called “polycaprolactones”, or hydroxycarboxylic acids, ω-hydroxycaproic acid for example, may likewise be employed.

It is, however, also possible to use polyesterpolyols of oleochemical origin. Polyesterpolyols of this kind may be prepared, for example, by complete ring opening of epoxidized triglycerides of an at least partly olefinically unsaturated fatty acid-containing fat mixture with one or more alcohols having 1 to 12 carbon atoms, with subsequent partial transesterification of the triglyceride derivatives to form alkyl ester polyols having 1 to 12 carbon atoms in the alkyl radical.

The polyesterpolyols used in B) have number-average molecular weights of 200 to 10 000 g/mol, preferably 1000 to 6000 g/mol.

The zirconium compounds used in C) correspond to the above-stated definition of the fluorine-bearing zirconium(IV) acetylacetonate complexes that are to be used.

The reaction of the monomeric asymmetric diisocyanates with the polyols takes place at a temperature of 20° C. to 150° C., preferably 25 to 100° C. and with particular preference 40 to 80° C.

The amount of catalyst used may vary from 1 to 10000 ppm, preference being given to using 20 to 1000 ppm and particular preference to using 100 to 500 ppm, based on total solids.

The polyurethane prepolymers of the invention are prepared preferably in a one-stage process. In this case the polyols of component B) are mixed, individually or as a mixture, with the isocyanate component A) and the homogeneous mixture is stirred until a constant NCO value is obtained. The reaction temperature chosen is 20° C. to 150° C., preferably 25° C. to 100° C. and more preferably 40° C. to 80° C. Preferably both reactants and the reaction product as well are liquid at the chosen reaction temperature, so that there is no need to use additional solvents for homogenizing and for lowering the viscosity of the reaction mixture.

The preparation of the polyurethane prepolymers containing terminal NCO groups can of course also take place continuously in a stirred tank cascade or in suitable mixing apparatus, such as high-speed mixers operating in accordance with the rotor-stator principle, for example.

The NCO content is determined by an NCO titrimetry process, customary in polyurethane chemistry, in accordance with DIN 1242.

For stopping the reaction or for catalyst deactivation it is possible optionally to add a mineral acid or organic acid such as hydrochloric acid, sulphuric acid, phosphoric acid or derivatives thereof, formic acid, acetic acid or another alkanoic acid or organic acid or an acid-releasing component, such as acid halides, for instance. Examples of suitable acid chlorides are formyl chloride, acetyl chloride, propionyl chloride and benzoyl chloride. Stopping the reaction is advantageous particularly if during prepolymer preparation one of the abovementioned known aminic or organometallic catalysts has been used.

Preference is given to using benzoyl chloride as stopper.

Where exclusively polyetherpolyols are used as polyol component B), the reactive polyurethane prepolymers of the invention contain less than 0.3%, preferably less than 0.2% and with particular preference less than 0.1% by weight of monomeric asymmetric diisocyanate.

Otherwise residual monomer contents of less than 1.0% by weight, preferably less than 0.5% by weight, are achieved.

The viscosity of the polyurethane prepolymers prepared by the process of the invention with exclusive use of polyetherpolyols is, at 25° C., 100 mPa·s to 150000 mPa·s, preferably 500 mPa·s to 100000 mPa·s and very preferably 500 mPa·s to 80000 mPa·s.

The invention further provides the prepolymers obtainable by the process of the invention and also provides for their use in the production of polyurethane plastics, coatings, casting compounds, assembly foams, rigid and integral foams, adhesive bonds and/or seals, preference being given to moisture-curing sealants and/or adhesives based on the prepolymers essential to the invention.

### EXAMPLES

Unless indicated otherwise all percentages are by weight.

The viscosities were determined at the measurement temperatures indicated in each case, using the Viskotester VT 550 rotational viscometer from Thermo Haake, Karlsruhe, DE with the SV measuring cup and the SV DIN 2 measuring equipment.

In Examples 1-3 the amount of free monomeric diisocyanate was determined by HPLC following derivatization of the samples with 9-(methylaminomethyl)anthracene.

Instrument: HPLC instrument: Hewlett Packard, HP 1050

Detection: Fluorescence detector Hewlett Packard, HP 1046a

Wavelength: ex.=244 nm, em.=404 nm

Response Time=1000 ms

PMT Gain=10

Separating column: LiChrospher 60 RP select B, 5 μm (125 mm*4.0 mm, Merck)

Mobile Phase: Eluent A: acetonitrile=100 ml, water=900 ml, tetrabutylammonium hydrogen sulphate=2 g

Eluent B: acetonitrile=900 ml, water=100 ml, tetrabutylammonium hydrogen sulphate=2 g

Gradient:

| T [min] | A [%] | B [%] |
|---|---|---|
| 0 | 40 | 60 |
| 5 | 40 | 60 |
| 8 | 10 | 90 |

Flow rate: 1.5 ml/min
Total run time: 15 min
Posr time: 5 min
Temperature: 40° C.
Injection volume: 10 μl

In Examples 4-14 and Comparative Examples 1-5 the amount of free monomeric diisocyanate was determined by means of gel permeation chromatography (GPC). The measurement was carried out at room temperature.

The eluent used was THF, the flow rate was 1 ml/min and the injection volume was 50 μl. Separating columns used were GPC columns packed with 5 μm separation material and having a porosity of 500 Å (MZ-Analysentechnik, Mainz, MZ-Gel SD-plus). The overall length of the separating columns was 120 cm. The detector used was a refractive index detector.

The NCO content of the prepolymers and reaction mixtures was determined in accordance with DIN EN 1242.

Polyether A: Polypropylene glycol prepared by DMC catalysis by the Impact® process, having a nominal functionality of 2 and a hydroxyl number of 56 mg KOH/g (Desmophen® 2062 BD, Bayer MaterialScience AG, Leverkusen, DE).

Polyether B: Polypropylene glycol prepared by DMC catalysis by the Impact® process, having a nominal functionality of 2 and a hydroxyl number of 28 mg KOH/g (Acclaim® 4200, Bayer MaterialScience AG, Leverkusen, DE).

Polyether C: Polypropylene glycol prepared by DMC catalysis by the Impact® process, having a nominal functionality of 2 and a hydroxyl number of 56 mg KOH/g (Desmophen 2061 BD, Bayer MaterialScience AG, Leverkusen, DE).

Polyether D: Polypropylene glycol prepared by DMC catalysis by the Impact® process, having a nominal functionality of 3 and a hydroxyl number of 28 mg KOH/g (Acclaim® 6300, Bayer MaterialScience AG, Leverkusen, DE).

Polyether E:

Polyetherpolyol having a nominal functionality of 2 and a hydroxyl number of 260 mg KOH/g, prepared by propoxylating propylene glycol (Desmophen 1262 BD, Bayer MaterialScience AG, Leverkusen, DE).

Polyester F: Polyesterpolyol with a composition of 33.5% by weight 1,6-hexanediol, 20.5% by weight neopentyl glycol and 46.0% by weight adipic acid, having a hydroxyl number of 56 mg KOH/g and an acid number of about 1.0 mg KOH/g.

Catalyst A: Zircoriium(IV) hexafluoroacetylacetonate, Strem Chemicals Inc., Kehl, Del.

Catalyst B: Zirconium(IV) trifluoroacetylacetonate, Sigma-Aldrich Chemie GmbH, Munich, Del.

Catalyst C: Dibutyltin dilaurate (DBTL), Goldschmidt TIB GmbH, Mannheim, DE under the designation Tegokat® 218.

Proglyde DMM: Dipropyleneglycoldimethylether

MPA: Methoxypropylacetate

eq cat: val cat, the assigned amount of material related to the central atom (metal)

cat ratio: amount of catalyst, the more catalyst is used the higher is the cat ratio.

### EXAMPLES 1A) TO 1G)

The reactive polyurethanes according to Table 1 were prepared by introducing 2,4′-MDI having a 2,4′ isomer content of at least 97.5% as monomeric asymmetric diisocyanate and heating it to 50° C. The heating was then switched off and polyether A was metered in over the course of 10 minutes. At a reaction temperature of 80° C. the reaction was continued over a period of 4 hours.

Thereafter the reaction mixture was cooled to room temperature and measurements were made of the NCO content, the free unreacted monomeric 2,4′-MDI content and the viscosity at 23° C. The measured data are reported in Table 1.

TABLE 1
Reaction of 2,4′-MDI with polyether A at different temperatures;
NCO/OH ratio 1:1. The viscosity was determined at 23° C.

| | | | | | NCO | Free | Viscosity |
|---|---|---|---|---|---|---|---|
| Ex. | eq cat | cat ratio | Catalyst | Temp. | [%] | MDI [wt %] | [mPa*s] |
| 1A | 5.834E−06 | 1.0 | DBTL | 80° C. | 2.4 | 0.01 | 18700 |
| 1B | 8.75E−06 | 1.5 | zirconium(IV) | 80° C. | 2.4 | 0.01 | 18500 |
| | | | hexafluoroacetylacetonate | | | | |
| 1C | 8.75E−06 | 1.5 | Bi 2-ethylhexanoate | 80° C. | 2.5 | 0.05 | 20900 |
| 1D | 8.75E−06 | 1.5 | none | 80° C. | 4.1 | n.c. | 1950 |
| 1E | 8.75E−06 | 1.5 | tin 2-ethylhexanoate | 80° C. | 2.6 | n.c. | 31900 |
| 1F | 8.75E−06 | 1.5 | silver(I) (1,5- | 80° C. | 4.1 | n.c. | 2000 |
| | | | cyclopentadienyl)(hexa- | | | | |
| | | | fluoroacetylacetonate) | | | | |
| 1G | 1.167E−05 | 2.0 | zirconium(IV) | 80° C. | 2.7 | n.c. | 18700 |
| | | | trifluoroacetylacetonate | | | | |

n.c. = reaction not complete

### EXAMPLES 2A) TO 2Y)

The reactive polyurethanes according to Table 2 were prepared by introducing 2,4′-MDI having a 2,4′ isomer content of at least 97.5% as monomeric asymmetric diisocyanate and heating it to 50° C. The heating was then switched off and polyether B was metered in over the course of 10 minutes. At a reaction temperature of 60° C. or 80° C. the reaction was continued over a period of 2 or 4 hours. Thereafter the reaction mixture was cooled to room temperature and measurements were made of the NCO content, the free unreacted monomeric 2,4′-MDI content and the viscosity at 23° C. The measured data are reported in Table 2.

TABLE 2
Reaction of 2,4′-MDI with polyether B at different temperatures;
NCO/OH ratio 1:1. The viscosity was determined at 23° C.

| | | | | | | NCO | Free | Viscosity |
|---|---|---|---|---|---|---|---|---|
| Ex. | eq cat | cat ratio | Catalyst | Time | Temp. | [%] | MDI [wt. %] | [mPa*s] |
| 2A | 0.0000052 | 1.0 | B(OEt)₃ | 4 h | 80° C. | n.c. | | |
| 2B | 0.0000157 | 3.0 | B(OEt)₃ | 4 h | 80° C. | n.c. | | |
| 2C | 0.0000052 | 1.0 | Bi 2-ethylhexanoate | 4 h | 60° C. | 1.3 | 0.01 | 16900 |
| 2D | 0.0000079 | 1.5 | Bi 2-ethylhexanoate | 2 h | 80° C. | 1.3 | 0.07 | 20100 |
| 2E | 7.859E−06 | 1.5 | Bi 2-ethylhexanoate | 2 h | 80° C. | 1.4 | 0.12 | 19700 |
| 2F | 0.0000052 | 1.0 | Bi neodecanoate | 4 h | 60° C. | 1.3 | 0.01 | 17100 |
| 2G | 0.0000079 | 1.5 | Bi neodecanoate | 2 h | 80° C. | 1.4 | 0.06 | 19300 |
| 2H | 7.859E−06 | 1.5 | Bi neodecanoate | 2 h | 80° C. | 1.4 | 0.04 | 20800 |
| 2J | 0.0000157 | 3.0 | Borane-pyridine | 4 h | 60° C. | n.c. | | |
| | | | complex | | | | | |
| 2K | 0.0000157 | 3.0 | Borane-pyridine | 4 h | 60° C. | n.c. | | |
| | | | complex | | | | | |
| 2L | 0.0000052 | 1.0 | DBTL | 4 h | 60° C. | 1.4 | 0.01 | 15700 |
| 2M | 0.0000052 | 1.0 | DBTL | 2 h | 80° C. | 1.3 | 0.01 | 17400 |
| 2N | 0.0000052 | 1.0 | DBTL | 2 h | 80° C. | 1.3 | 0.01 | 19500 |
| 2O | 0.0000262 | 5.0 | Sb(OiPr)₃ | 4 h | 80° C. | n.c. | | |
| 2P | 0.0000052 | 1.0 | Sn 2-ethylhexanoate | 4 h | 60° C. | 1.3 | 0.21 | 27700 |
| 2Q | 0.0000079 | 1.5 | Sn 2-ethylhexanoate | 2 h | 80° C. | 1.3 | 0.34 | 28600 |
| 2R | 7.859E−06 | 1.5 | Sn 2-ethylhexanoate | 2 h | 80° C. | 1.5 | 0.38 | 33100 |
| 2S | 0.0000157 | 3.0 | Tetrakis(dimethyl- | 4 h | 60° C. | n.c. | | |
| | | | amino)silane | | | | | |
| 2T | 0.0000157 | 3.0 | Tetrakis(dimethyl- | 4 h | 60° C. | n.c. | | |
| | | | amino)silane | | | | | |
| 2U | 0.0000262 | 5.0 | Ti(OBu)₄ | 4 h | 60° C. | 1.4 | 0.01 | 19400 |
| 2V | 0.0000052 | 1.0 | Ti(OBu)₄ | 4 h | 60° C. | n.c. | | |
| 2W | 0.0000157 | 3.0 | Tris-(dimethylamino)- | 4 h | 60° C. | n.c. | | |
| | | | borane | | | | | |
| 2X | 0.0000262 | 5.0 | VO(OiPr)₃ | 4 h | 80° C. | n.c. | | |
| 2Y | 0.0000052 | 1.0 | Zn 2-ethylhexanoate | 4 h | 60° C. | 1.5 | 0.04 | 16400 |

n.c. = reaction not complete

### EXAMPLES 3A) TO 3M)

The reactive polyurethanes according to Table 3 were prepared by introducing 2,4′-MDI having a 2,4′ isomer content of at least 97.5% as monomeric asymmetric diisocyanate in the solvent indicated in the table, at the corresponding concentration, and heating it to 50° C. The heating was then switched off and polyether B was metered in over the course of 10 minutes. At a reaction temperature of 80° C. the reaction was continued over a period of 4 hours (experiment 3 h: 2 hours). Thereafter the reaction mixture was cooled to room temperature and measurements were made of the NCO content, the free unreacted monomeric 2,4′-MDI content and the viscosity at 23° C. The measured data are reported in Table 3.

TABLE 3
Reaction of 2,4′-MDI with polyether B at different temperatures.
The NCO/OH ratio is 1:1. The viscosity was determined at 23° C.

| | | | | | | | NCO | MDI | Viscos. |
|---|---|---|---|---|---|---|---|---|---|
| Ex. | eq cat | Cat Ratio | Catalyst | Conc. | Time | Temp. | [%] | [wt %] | [mPa*s] |
| 3A | 0.0000157 | 3.0 | Aluminium(III) | 10%, MPA | 4 h | 80° C. | n.c. | | 2190 |
| | | | trifluoroacetylacetonate | | | | | | |
| 3B | 0.0000052 | 1.0 | DBTL | 10%, MPA | 4 h | 80° C. | 1.32 | <0.1 | 16330 |
| 3C | 0.0000157 | 3.0 | Iron(III) | 10%, MPA | 4 h | 80° C. | 1.28 | <0.1 | 24000 |
| | | | hexafluoroacetyl- | | | | | | |
| | | | acetonate | | | | | | |
| 3D | 0.0000157 | 3.0 | Ethyltrimethoxy | 10%, MPA | 4 h | 80° C. | n.c. | ? | 2140 |
| | | | germanium | | | | | | |
| 3E | 0.0000157 | 3.0 | Copper(II) | 10%, MPA | 4 h | 80° C. | 1.6 | 0.2 | 10440 |
| | | | trifluoroacetylacetonate | | | | | | |
| 3F | 0.0000157 | 3.0 | Magnesium(II) | 10%, MPA | 4 h | 80° C. | n.c. | | 1940 |
| | | | hexafluoroacetyl- | | | | | | |
| | | | acetonate | | | | | | |
| 3G | | 0.0 | none | 10%, MPA | 4 h | 80° C. | n.c. | | 2220 |
| 3H | 7.859E−06 | 1.5 | Trimethylantimony | 10%, MPA | 2 h | 80° C. | n.c. | | |
| | | | dichloride | | | | | | |
| 3J | 0.0000157 | 3.0 | Yttrium(III) | 10%, MPA | 4 h | 80° C. | n.c. | | 2220 |
| | | | hexafluoroacetyl- | | | | | | |
| | | | acetonate | | | | | | |
| 3K | 0.0000157 | 3.0 | Tin(II) | 10%, MPA | 4 h | 80° C. | 1.43 | 0.2 | 19550 |
| | | | hexafluoroacetyl- | | | | | | |
| | | | acetonate | | | | | | |
| 3L | 8.75E−06 | 1.5 | Zirconium(IV) | 10% in | 4 h | 80° C. | 1.32 | 0.01 | 16550 |
| | | | hexafluoroacetyl- | Proglyde | | | | | |
| | | | acetonate | DMM | | | | | |
| 3M | 1.167E−05 | 2.0 | Zirconium(IV) | 10% in | 4 h | 80° C. | 1.34 | <0.1 | 18800 |
| | | | trifluoroacetylacetonate | Proglyde | | | | | |
| | | | | DMM | | | | | |

n.c. = reaction not complete

### EXAMPLE 4

In a heatable and coolable glass flask provided with an agitator mechanism and a dropping funnel, 20.26 g (0.081 mol) of 2,4′-MDI (2,4′ isomer content>97.5%) were melted at a temperature of 50° C. Added to the melted diisocyanate with stirring were first 30 mg of catalyst A and then 179.74 g (0.045 mol) of polyether B, which had been dewatered beforehand at a temperature of 100° C. under a vacuum of 15 mbar, these additions taking place such that the temperature of 50° C. did not rise. Following complete addition of the polyether the reaction mixture was heated to 60° C. and stirred further at this temperature until, after a reaction time of 4 hours, a constant NCO content of 1.43% (theory: 1.51%) was reached. Thereafter the catalyst was deactivated by adding 45 mg of benzoyl chloride and the product was dispensed. The end product had an NCO content of 1.43%.

### EXAMPLE 5

In a heatable and coolable glass flask provided with an agitator mechanism and a dropping funnel, 20.26 g (0.081 mol) of 2,4′-MDI (2,4′ isomer content>97.5%) were melted at a temperature of 50° C. Added to the melted diisocyanate with stirring were first 30 mg of catalyst B and then 179.74 g (0.045 mol) of polyether B, which had been dewatered beforehand at a temperature of 100° C. under a vacuum of 15 mbar, these additions taking place such that the temperature of 50° C. did not rise. Following complete addition of the polyether the reaction mixture was heated to 60° C. and stirred further at this temperature until, after a reaction time of 4 hours, a constant NCO content of 1.42% (theory: 1.51%) was reached. Thereafter the catalyst was deactivated by adding 45 mg of benzoyl chloride and the product was dispensed. The end product had an NCO content of 1.42%.

### EXAMPLE 6

In a heatable and coolable glass flask provided with an agitator mechanism and a dropping funnel, 151.53 g (0.606 mol) of 2,4′-MDI (2,4′ isomer content>97.5%) were melted at a temperature of 50° C. Added to the melted diisocyanate with stirring were first 225 mg of catalyst A and then a mixture, dewatered beforehand at a temperature of 100° C. under a vacuum of 15 mbar, of 269.70 g (0.067 mol) of polyether B and 1078.77 g (0.18 mol) of polyether D, these additions taking place such that the temperature of 50° C. did not rise. Following complete addition of the polyether mixture the reaction mixture was heated to 60° C. and stirred further at this temperature until, after a reaction time of 2 hours, a constant NCO content of 1.50% (theory: 1.50%) was reached. Thereafter the catalyst was deactivated by adding 375 mg of benzoyl chloride and the product was dispensed. The end product had an NCO content of 1.50%.

### EXAMPLE 7

In a heatable and coolable glass flask provided with an agitator mechanism and a dropping funnel, 151.53 g (0.606 mol) of 2,4′-MDI (2,4′ isomer content>97.5%) were melted at a temperature of 50° C. Added to the melted diisocyanate with stirring were first 225 mg of catalyst A and then a mixture, dewatered beforehand at a temperature of 100° C. under a vacuum of 15 mbar, of 1078.77 g (0.27 mol) of polyether B and 269.70 g. (0.045 mol) of polyether D, these additions taking place such that the temperature of 50° C. did not rise. Following complete addition of the polyether mixture the reaction mixture was heated to 60° C. and stirred further at this temperature until, after a reaction time of 2 hours, a constant NCO content of 1.36% (theory: 1.50%) was reached. Thereafter the catalyst was deactivated by adding 375 mg of benzoyl chloride and the product was dispensed. The end product had an NCO content of 1.36%.

### EXAMPLE 8

In a heatable and coolable glass flask provided with an agitator mechanism and a dropping funnel, 32.85 g (0.131 mol) of 2,4′-MDI (2,4′ isomer content>97.5%) were melted at a temperature of 50° C. Added to the melted diisocyanate with stirring were first 30 mg of catalyst A and then 167.15 g (0.084 mol) of polyether C, which had been dewatered beforehand at a temperature of 100° C. under a vacuum of 15 mbar, these additions taking place such that the temperature of 50° C. did not rise. Following complete addition of the polyether the reaction mixture was heated to 60° C. and stirred further at this temperature until, after a reaction time of 2 hours, a constant NCO content of 2.13% (theory: 2.0%) was reached. Thereafter the catalyst was deactivated by adding 40 mg of benzoyl chloride and the product was dispensed. The end product had an NCO content of 2.13%.

### EXAMPLE 9

In a heatable and coolable glass flask provided with an agitator mechanism and a dropping funnel, 35.51 g (0.142 mol) of 2,4′-MDI (2,4′ isomer content>97.5%) were melted at a temperature of 50° C. Added to the melted diisocyanate with stirring were first 30 mg of catalyst A and then 164.49 g (0.082 mol) of polyether C, which had been dewatered beforehand at a temperature of 100° C. under a vacuum of 15 mbar, these additions taking place such that the temperature of 50° C. did not rise. Following complete addition of the polyether the reaction mixture was heated to 60° C. and stirred further at this temperature until, after a reaction time of 4 hours, a constant NCO content of 2.46% (theory: 2.5%) was reached. Thereafter the catalyst was deactivated by adding 40 mg of benzoyl chloride and the product was dispensed. The end product had an NCO content of 2.46%.

### EXAMPLE 10

In a heatable and coolable glass flask provided with an agitator mechanism and a dropping funnel, 36.68 g (0.147 mol) of pure 2,4′-MDI (2,4′ isomer content>97.5%) were melted at a temperature of 50° C. Added to the melted diisocyanate with stirring were first 30 mg of catalyst A and then 163.32 g (0.082 mol) of polyether C, which had been dewatered beforehand at a temperature of 100° C. under a vacuum of 15 mbar, these additions taking place such that the temperature of 50° C. did not rise. Following complete addition of the polyether the reaction mixture was heated to 60° C. and stirred further at this temperature until, after a reaction time of 5 hours, a constant NCO content of 2.69% (theory: 2.74%) was reached. Thereafter the catalyst was deactivated by adding 40 mg of benzoyl chloride and the product was dispensed. The end product had an NCO content of 2.69%.

### EXAMPLE 11

In a heatable and coolable glass flask provided with an agitator mechanism and a dropping funnel, 96.16 g (0.385 mol) of pure 2,4′-MDI (2,4′ isomer content>97.5%) were melted at a temperature of 50° C. Added to the melted diisocyanate with stirring were first 30 mg of catalyst A and then 103.86 g (0.242 mol) of polyether E, which had been dewatered beforehand at a temperature of 100° C. under a vacuum of 15 mbar, these additions taking place such that the temperature of 50° C. did not rise. Following complete addition of the polyether the reaction mixture was heated to 60° C. and stirred further at this temperature until, after a reaction time of 3.5 hours, a constant NCO content of 5.67% (theory: 6.0%) was reached. Thereafter the catalyst was deactivated by adding 40 mg of benzoyl chloride and the product was dispensed. The end product had an NCO content of 5.67%.

### EXAMPLE 12

In a heatable and coolable glass flask provided with an agitator mechanism and a dropping funnel, 47.7 g (0.191 mol) of pure 2,4′-MDI (2,4′ isomer content>97.5%) were melted at a temperature of 50° C. Added to the melted diisocyanate with stirring were first 30 mg of catalyst A and then a mixture, dewatered beforehand at a temperature of 100° C. under a vacuum of 15 mbar, of 113.22 g (0.028 mol) of polyether B and 39.08 g (0.091 mol) of polyether E, these additions taking place such that the temperature of 50° C. did not rise. Following complete addition of the polyether mixture the reaction mixture was heated to 60° C. and stirred further at this temperature until, after a reaction time of 4 hours, a constant NCO content of 2.84% (theory: 3.0%) was reached. Thereafter the catalyst was deactivated by adding 40 mg of benzoyl chloride and the product was dispensed. The end product had an NCO content of 2.84%.

### EXAMPLE 13

In a heatable and coolable glass flask provided with an agitator mechanism and a dropping funnel, 37.74 g (0.151 mol) of pure 2,4′-MDI (2,4′ isomer content>97.5%) were melted at a temperature of 70° C. Added to the melted diisocyanate with stirring were first 30 mg of catalyst B and then 162.26 g (0.084 mol) of polyether F, which had been dewatered beforehand at a temperature of 100° C. under a vacuum of 15 mbar, these additions taking place such that the temperature of 70° C. did not rise. Following complete addition of the polyether the reaction mixture was stirred further at 70° C. until, after a reaction time of 1 hour, a constant NCO content of 2.79% (theory: 2.82%) was reached. Thereafter the catalyst was deactivated by adding 60 mg of benzoyl chloride and the product was dispensed. The end product had an NCO content of 2.79%.

### EXAMPLE 14

In a heatable and coolable glass flask provided with an agitator mechanism and a dropping funnel, 37.74 g (0.151 mol) of pure 2,4′-MDI (2,4′ isomer content>97.5%) were melted at a temperature of 70° C. Added to the melted diisocyanate with stirring were first 30 mg of catalyst A and then 162.26 g (0.084 mol) of polyether F, which had been dewatered beforehand at a temperature of 100° C. under a vacuum of 15 mbar, these additions taking place such that the temperature of 70° C. did not rise. Following complete addition of the polyether the reaction mixture was stirred further at 70° C. until, after a reaction time of 1.5 hours, a constant NCO content of 2.78% (theory: 2.82%) was reached. Thereafter the catalyst was deactivated by adding 60 mg of benzoyl chloride and the product was dispensed. The end product had an NCO content of 2.78%.

### COMPARATIVE EXAMPLE 1

In a heatable and coolable glass flask provided with an agitator mechanism and a dropping funnel, 36.68 g (0.147 mol) of pure 2,4′-MDI (2,4′ isomer content>97.5%) were melted at a temperature of 50° C. Added to the melted diisocyanate with stirring were 163.32 g (0.082 mol) of polyether C, which had been dewatered beforehand at a temperature of 100° C. under a vacuum of 15 mbar, the addition taking place such that the temperature of 50° C. did not rise. Following complete addition of the polyether the reaction mixture was heated to 60° C. and stirred further at this temperature until, after a reaction time of 32 hours, a constant NCO content of 2.73% (theory: 2.74%) was reached. Thereafter the product was dispensed. The end product had an NCO content of 2.73%.

### COMPARATIVE EXAMPLE 2

In a heatable and coolable glass flask provided with an agitator mechanism and a dropping funnel, 36.68 g (0.147 mol) of pure 2,4′-MDI (2,4′ isomer content>97.5%) were melted at a temperature of 50° C. Added to the melted diisocyanate with stirring were first 20 mg of catalyst C and then 163.32 g (0.082 mol) of polyether C, which had been dewatered beforehand at a temperature of 100° C. under a vacuum of 15 mbar, these additions taking place such that the temperature of 50° C. did not rise. Following complete addition of the polyether the reaction mixture was heated to 60° C. and stirred further at this temperature until, after a reaction time of 5 hours, a constant NCO content of 2.72% (theory: 2.74%) was reached. Thereafter the catalyst was deactivated by adding 30 mg of benzoyl chloride and the product was dispensed. The end product had an NCO content of 2.72%.

### COMPARATIVE EXAMPLE 3

In a heatable and coolable glass flask provided with an agitator mechanism and a dropping funnel, 20.26 g (0.081 mol) of pure 2,4′-MDI (2,4′ isomer content>97.5%) were melted at a temperature of 50° C. Added to the melted diisocyanate with stirring were 179.74 g (0.045 mol) of polyether B, which had been dewatered beforehand at a temperature of 100° C. under a vacuum of 15 mbar, the addition taking place such that the temperature of 50° C. did not rise. Following complete addition of the polyether the reaction mixture was heated to 60° C. and stirred further at this temperature until, after a reaction time of 60 hours, a constant NCO content of 1.49% (theory: 1.51%) was reached. Thereafter the product was dispensed. The end product had an NCO content of 1.49%.

### COMPARATIVE EXAMPLE 4

In a heatable and coolable glass flask provided with an agitator mechanism and a dropping funnel, 20.26 g (0.081 mol) of pure 2,4′-MDI (2,4′ isomer content>97.5%) were melted at a temperature of 50° C. Added to the melted diisocyanate with stirring were first 20 mg of catalyst C and then 179.74 g (0.045 mol) of polyether C, which had been dewatered beforehand at a temperature of 100° C. under a vacuum of 15 mbar, these additions taking place such that the temperature of 50° C. did not rise. Following complete addition of the polyether the reaction mixture was heated to 60° C. and stirred further at this temperature until, after a reaction time of 4 hours, a constant NCO content of 1.37% (theory: 1.51%) was reached. Thereafter the catalyst was deactivated by adding 30 mg of benzoyl chloride and the product was dispensed. The end product had an NCO content of 1.37%.

### COMPARATIVE EXAMPLE 5

In a heatable and coolable glass flask provided with an agitator mechanism and a dropping funnel, 37.74 g (0.151 mol) of pure 2,4′-MDI (2,4′ isomer content>97.5%) were melted at a temperature of 70° C. Added to the melted diisocyanate with stirring were 162.26 g (0.084 mol) of polyester F, which had been dewatered beforehand at a temperature of 100° C. under a vacuum of 15 mbar, the addition taking place such that the temperature of 70° C. did not rise. Following complete addition of the polyester the reaction mixture was stirred further at 70° C. until, after a reaction time of 7.5 hours, a constant NCO content of 2.82% (theory: 2.82%) was reached. Thereafter the product was dispensed. The end product had an NCO content of 2.82%.

TABLE 4
Residual monomer contents and viscosities of Examples
4-12 and of Comparative Examples 1-4

| | Residual monomer | Viscosity at | Viscosity at |
|---|---|---|---|
| Examples | [% by weight] | 25° C. [mPa*s] | 100° C. [mPa*s] |
| 4 | <0.05 | 16000 | 425 |
| 5 | 0.1 | 17900 | 410 |
| 6 | <0.1 | 19750 | 648 |
| 7 | <0.1 | 20700 | 598 |
| 8 | 0.1 | 13900 | 269 |
| 9 | 0.1 | 12700 | 227 |
| 10 | 0.2 | 16200 | 315 |
| 11 | 0.2 | not determined | 672 |
| 12 | <0.05 | 81800 | 557 |
| C1 | 0.9 | 18450 | 333 |
| C2 | 0.3 | 16390 | 410 |
| C3 | 0.5 | 15900 | 521 |
| C4 | <0.05 | 18425 | 445 |

TABLE 5
Residual monomer contents and viscosities of Examples
13-14 and of Comparative Example 5

| | Residual monomer | Viscosity at |
|---|---|---|
| Example | [% by weight] | 100° C. [mPa*s] |
| 13 | 0.9 | 1830 |
| 14 | 1.0 | 1740 |
| C5 | 1.7 | 2760 |

From the inventive and comparative examples it is clear that through the use of the catalysts of the invention success is achieved in preparing reactive polyurethane prepolymers combining drastically reduced residual monomer contents with significantly lower viscosity and that it is possible to do without the use of tin-containing catalysts.

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. A process for preparing urethane-containing compounds comprising the step of reacting an isocyanate-containing compound with an isocyanate-reactive compound in the presence of zirconium(IV) acetylacetonate complexes as catalyst, where at least one acetylacetonate ligand present in the catalyst bears a fluorine substituent.

2. The process according to claim 1, wherein the zirconium(IV) acetylacetonate complexes bear as ligands exclusively acetylacetonate ligands having in each case at least one CF₃ group.

3. Process for preparing NCO-functional polyurethane prepolymers having an NCO content of 0.2%-12% by weight, in which
A) at least one monomeric asymmetric diisocyanate having a molecular weight of 160 g/mol to 500 g/mol and
B) at least one polyetherpolyol and/or polyesterpolyol
C) are reacted with one another in the presence of zirconium(IV) acetylacetonate complexes, at least one acetylacetonate ligand present in the catalyst bearing a fluorine substituent,
in a ratio of isocyanate groups to hydroxyl groups of 1.05:1 to 2.0:1.

4. Process according to claim 3, wherein the asymmetric diisocyanates in component A) are selected from the group consisting of 2,4-tolylene diisocyanate (2,4-TDI), diphenylmethane 2,4′-diisocyanate (2,4′-MDI), 1-isocyanatomethyl-3-isocyanato-1,5,5-trimethylcyclohexane (isophorone diisocyanate, IPDI) or mixtures thereof.

5. Process according to claim 3, wherein in C) zirconium(IV) acetylacetonate complexes are used which bear as ligands exclusively acetylacetonate ligands having in each case at least one CF₃ group.

6. NCO-functional polyurethane prepolymers obtained from a process according to claim 3.

7. Coatings, adhesive bonds and/or sealants obtainable using NCO-functional polyurethane prepolymers according to claim 6.
